(19) United States
(12) Patent Application Publication
(10) Pub. No.: US 2024/0405382 A1
(43) Pub. Date: Dec. 5, 2024

(54) SECONDARY BATTERY

(71) Applicant: KABUSHIKI KAISHA TOSHIBA, Tokyo (JP)

(72) Inventors: Takuma YANO, Kita Tokyo (JP); Shusuke MORITA, Yokohama Kanagawa (JP); Yoshiaki ARAKI, Yokohama Kanagawa (JP)

(73) Assignee: KABUSHIKI KAISHA TOSHIBA, Tokyo (JP)

(21) Appl. No.: 18/805,738

(22) Filed: Aug. 15, 2024

Related U.S. Application Data
(63) Continuation of application No. PCT/JP2022/006633, filed on Feb. 18, 2022.

(51) Int. Cl. H01M 50/533; H01M 50/103; H01M 50/15; H01M 50/538; H01M 50/55

(52) U.S. Cl. CPC H01M 50/533; H01M 50/103; H01M 50/15; H01M 50/538; H01M 50/55

(57) ABSTRACT

According to one embodiment, a secondary battery includes an outer container with a lid, an electrode body stored in the outer container and including an electrode group, a positive electrode current collecting tab group and a negative electrode current collecting tab group, output terminals on the lid, a positive electrode lead, and a negative electrode lead. A second joint portion of the electrode leads has a first joint surface and a second joint surface opposing each other. A part of current collector tab groups of the same polarity is joined to the first joint surface, and another part of the group of current collector tabs of the same polarity is joined to the second joint surface and opposing the part of the current collector tab groups across the second joint portion.

### CROSS-REFERENCE TO RELATED APPLICATIONS

This application is a Continuation Application of PCT Application No. PCT/JP2022/006633, filed Feb. 18, 2022, the entire contents of which are incorporated herein by reference.

### FIELD

Embodiments described herein relate generally to a secondary battery.

### BACKGROUND

In recent years, secondary batteries with high energy density, for example, lithium-ion secondary batteries, have been widely used as power sources for electronic devices and electric vehicles. Such secondary batteries include an electrode body having a positive and negative electrode and a nonaqueous electrolyte in a rectangular-shaped outer container formed of aluminum or aluminum alloy. The lid of the outer container is provided with a positive output terminal, negative output terminal, sealing plate, gas discharge valve, etc., and the positive output terminal and the negative output terminal are connected to the positive electrode current collecting tab and the negative electrode current collecting tab of the electrode body via the positive electrode lead and the negative electrode lead provided inside the outer container, respectively.

In the manufacturing process of secondary batteries as described above, current-collecting tabs are joined to the leads by laser welding, ultrasonic bonding, or other methods. In the manufacturing process, the above bonding process is relatively complicated. In particular, in the case of a secondary battery with multiple electrode bodies and multiple current-collecting tabs, the joining of current-collecting tabs can be more complicated.

### BRIEF DESCRIPTION OF THE DRAWINGS

FIG. 1 is a perspective view of an exterior appearance of a secondary battery of a first embodiment.

FIG. 2 is a perspective view of the secondary battery, depicted in a disassembled manner.

FIG. 3 is a perspective view of an electrode body of the secondary battery, depicted in a partially expanded manner.

FIG. 4 is a front view of the secondary battery, depicted omitting an outer container.

FIG. 5 is a cross-sectional view of the secondary battery, taken along line A-A.

FIG. 6 is a cross-sectional view of the secondary battery, taken along line B-B.

FIG. 7 is a schematic view of joining process of electrode leads and current collecting tubs.

FIG. 8A is a schematic perspective view of the electrode leads and the current collecting tubs in a joint state.

FIG. 8B is a schematic perspective view of the electrode leads and the current collecting tubs in a joint state, each viewed from a different angle.

FIG. 9A is a schematic cross-sectional view of the electrode leads and the current collecting tubs.

FIG. 9B is a schematic cross-sectional view of other electrode leads and current collecting tubs.

FIG. 10 is a perspective view of a secondary battery of a second embodiment, depicted omitting an outer container.

FIG. 11 is a cross-sectional view of the secondary battery of the second embodiment, corresponding to FIG. 5.

FIG. 12 is a cross-sectional view of the secondary battery of the second embodiment, corresponding to FIG. 6.

FIG. 13 is a perspective view of a secondary battery of a third embodiment, depicted in a disassembled manner.

FIG. 14 is a perspective view of the secondary battery of the third embodiment, depicted in a partially expanded manner.

FIG. 15 is a cross-sectional view of the secondary battery of the third embodiment.

FIG. 16 is a cross-sectional view of the secondary battery of the third embodiment, corresponding to FIG. 6.

FIG. 17A is a front view of a joint process of an electrode lead and a current collecting tub of the third embodiment.

FIG. 17B is a schematic side view of a joint state of the electrode lead and the current collecting tub.

FIG. 18 is a schematic view of a joint process of an electrode lead and a current collecting tub of a secondary battery of a first modification.

FIG. 19 is a schematic view of an electrode body and an electrode lead of a secondary battery of a second modification.

### DETAILED DESCRIPTION

Various embodiments will be described hereinafter with reference to the accompanying drawings. In general, according to one embodiment, a secondary battery comprises an outer container with a lid; an electrode body including an electrode group with a positive electrode plate and a negative electrode plate, a positive electrode current collecting tab group with a plurality of positive electrode current collecting tabs extending from the electrode group, and a negative electrode current collecting tab group with a plurality of negative electrode current collecting tabs extending from the electrode group, the electrode body stored in the outer container; a pair of output terminals on the lid; a positive electrode lead having a first joint portion connected to one of the output terminals and a second joint portion connected to the positive electrode current collecting tab group, the positive electrode lead electrically connecting the positive electrode current collecting tab group to the output terminals; and a negative electrode lead having a first joint portion connected to the other output terminal and a second joint portion connected to the negative electrode current collecting tab group, the negative electrode lead electrically connecting the negative electrode current collecting tab group to the output terminal. The second joint portion has a first joint surface and a second joint surface opposing each other, and a part of current collector tab groups of the same polarity is joined to the first joint surface, and another part of the group of current collector tabs of the same polarity is joined to the second joint surface and opposing the part of the current collector tab groups across the second joint portion.

Note that the disclosure is merely an example, and proper changes in keeping with the spirit of the invention, which are easily conceivable by a person of ordinary skill in the art, come within the scope of the invention as a matter of course. In addition, in some cases, in order to make the description clearer, the drawings show schematic illustration rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

### First Embodiment

The secondary battery of the first embodiment will be described in detail.

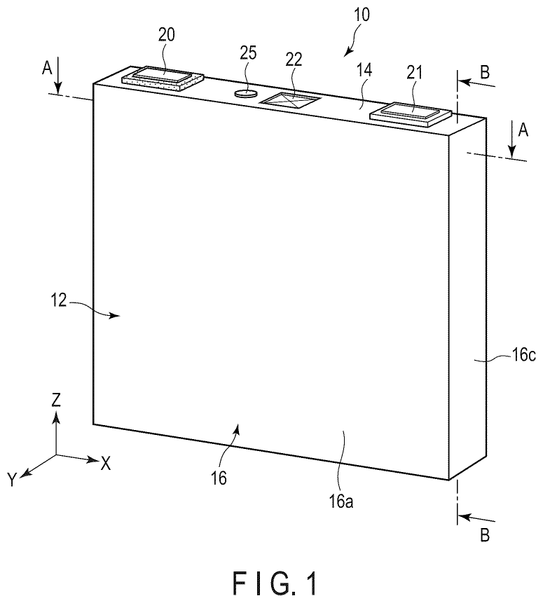

FIG. 1 is a perspective view of the external appearance of the secondary battery of the first embodiment.

As in the figure, a secondary battery 10 is a non-aqueous electrolyte secondary battery, such as a lithium ion battery, and has a flat, rectangular-shaped outer container 12 and an electrode body 30 described below, which is stored with the non-aqueous electrolyte in the outer container 12. The outer container 12 is, for example, an outer can (battery case) formed of a metal plate such as aluminum, aluminum alloy, iron, or stainless steel.

The outer container 12 includes a container body 16 with an open top end and a rectangular plate-shaped lid 14 which is welded to the container body 16 and closes the opening of the container body 16, forming an airtight interior. The lid 14 has a positive electrode terminal 20 and a negative electrode terminal 21 as a pair of output terminals, pressure relief valve (safety valve) 22, and inlet. The inlet is sealed by a disk-shaped sealing lid 25.

The longitudinal direction of the lid 14 and container body 16 is defined as X, the width direction of the lid 14 and container body 16 orthogonal to the longitudinal direction X as Y, and the height direction of the container body 16 as Z.

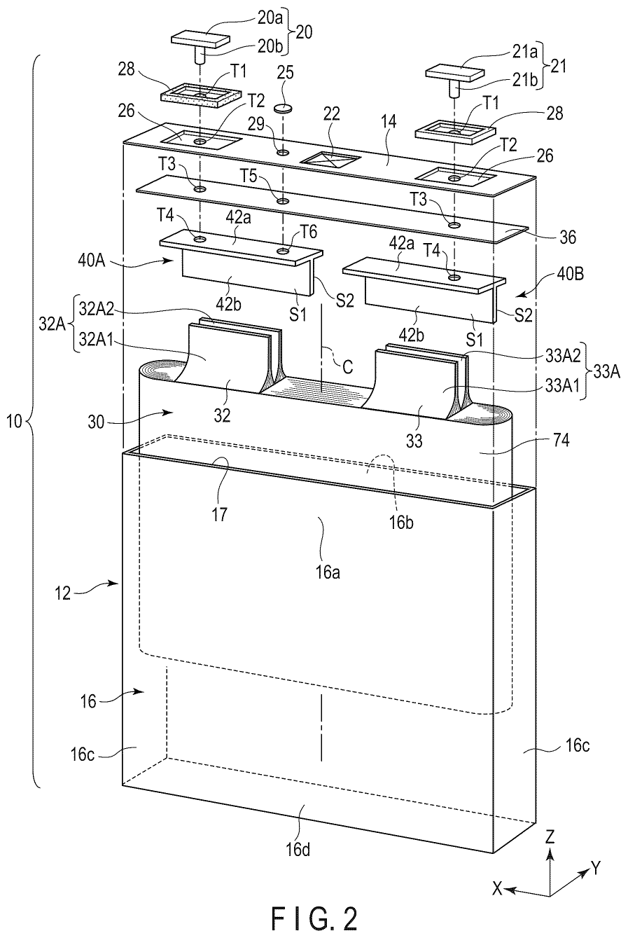

FIG. 2 is a perspective view of the secondary battery, depicted in a disassembled manner.

As in the figure, the container body 16 of the outer container 12 includes a rectangular long side wall 16a, rectangular long side wall 16b parallel and opposed to the long side wall 16a at intervals, a pair of short side walls 16c opposed to each other, and bottom wall 16d. The top edges of the pair of long side walls 16a and 16b and the top edge of the pair of short side walls 16c define a rectangular-shaped upper opening 17.

The lid 14 is formed as a rectangular plate approximately equal in size to the upper opening 17. The lid 14 is fixed to the container body 16 with its outer edge welded to the upper periphery of the container body 16, closing the upper opening 17.

Rectangular-shaped recesses 26 are formed at each end portion of the lid 14 in the longitudinal direction X. A sealing material, for example, gasket 28, formed of synthetic resin, glass, or other insulating material is attached to each of the recesses 26. Through holes T1 and T2 are provided in the center of each gasket 28 and recess 26.

The positive electrode terminal 20 has an approximately rectangular terminal body 20a and a connecting rod 20b extending downward from the bottom of the terminal body 20a. The positive electrode terminal 20 is mounted on the gasket 28 with the connecting rod 20b inserted through the through holes T1 and T2 of the gasket 28 and recess 26. Similarly, the negative electrode terminal 21 has an approximately rectangular terminal body 21a and a connecting rod 21b extending downward from the bottom of the terminal body 21a. The negative electrode terminal 21 is mounted on the gasket 28 with the connecting rod 21b inserted through the through holes T1 and T2 of the gasket 28 and recess 26.

The lid 14 has a safety valve (pressure relief valve) 22, which functions as a gas venting mechanism, and a nonaqueous electrolyte inlet 29. The safety valve 22 is formed in the center of the longitudinal direction X of the lid 14 and is located between the positive and negative electrode terminals 20 and 21. The safety valve 22 is formed by making some areas of the lid 14 about half as thick as the thickness of other areas. When gas is generated in the outer container 12 due to an abnormal mode of the secondary battery 10, etc., and the internal pressure of the outer container 12 rises above a predetermined value, the safety valve 22 is opened to reduce the internal pressure and prevent the outer container 12 from bursting or other problems.

An inlet 29 is formed in the lid 14 between the positive electrode terminal 20 and the safety valve 22. After pouring the nonaqueous electrolyte into the outer container 12 through the inlet 29, the inlet 29 is sealed with, for example, a disk-shaped sealing lid 25.

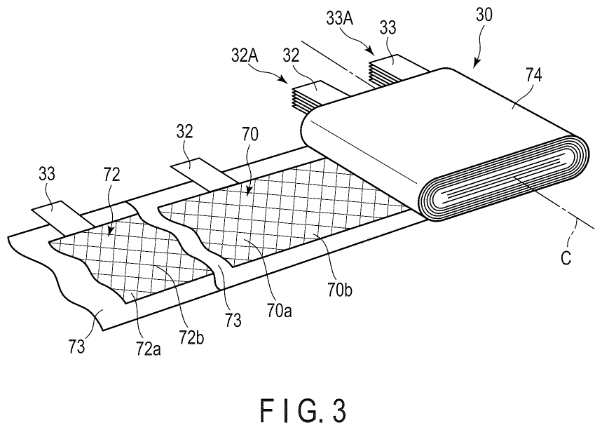

FIG. 3 shows an example of an electrode body.

In one example, a so-called wound electrode body is used as the electrode body 30 stored in the outer container 12. As in FIG. 3, the electrode body 30 has a group of electrodes 74 formed into a flat rectangular shape by, for example, winding the sheet-shaped positive and negative electrode plates 70 and 72, respectively, spirally around the winding axis C with a sheet-shaped separator 73 interposed therebetween, and further compressing them radially so that the cross-sectional shape thereof is almost the same rectangular shape as that of the outer container 12. The electrode group 74 is formed into a flat rectangular shape by winding the electrode group 74 around the outer container 12. A separator 73 is placed on the outermost layer (outermost circumference) of the electrode group 74. The electrode group 74 is held in a wound state by a winding tape or the like, which is not shown in the figure.

The positive electrode plate 70 has, for example, a strip-shaped positive electrode current collector 70a formed of metal foil, positive electrode active material layer 70b formed on at least one side of the positive electrode current collector 70a, and a plurality of positive electrode current collection tabs 32, each of which is a strip-shaped, extending in a direction parallel to the wound axis C from multiple locations on a long side of the positive electrode current collector 70a.

The negative electrode plate 72 has a strip-shaped negative electrode current collector 72a formed of metal foil, negative electrode active material layer 72b formed on at least one side of the negative electrode current collector 72a, and a plurality of negative electrode current collection tabs 33, each of which is a strip-shaped, extending in a direction parallel to the winding axis C from several locations on the long side of the negative electrode current collector 72a.

The positive electrode current collection tab 32 and the negative electrode current collection tab 33 may each be formed by punching out a current collector. That is, each current collector and current collecting tab is formed of, for example, a metal foil. The thickness of the metal foil, i.e., the thickness per current-collecting tab, should be between 5 and 50 μm. A thickness of 5 μm or more prevents breakage of the current collector and current collection tabs during manufacturing and enables high current collection efficiency. It is also possible to avoid dissolution of the current collector tabs when a large current is applied. By reducing the thickness to 50 μm or less, the number of laps constituting the electrode body can be increased while reducing the increase in the thickness of the electrode body. Preferably, the thickness of the metallic foil is between 10 and 20 μm. The material of the metal foil can be aluminum, aluminum alloy, copper or copper alloy, for example, although it can vary depending on the type of active material used for the positive and negative electrodes.

By stacking and winding the positive electrode plate 70, separator 73, and negative electrode plate 72, the positive electrode current-collecting tabs 32 are laminated side by side in the thickness direction of the electrode group 74 to form the positive electrode current-collecting tab group 32A. Similarly, a plurality of negative electrode current collecting tabs 33 are laminated side by side in the thickness direction of the electrode group 74 to form negative electrode current collecting tab group 33A. The positive electrode current collecting tab group 32A and the negative electrode current collecting tab group 33A extend in the same direction in the axial direction from one end of the electrode group 74 and are located apart from each other in the longitudinal direction of the electrode group 74, which is orthogonal to the axial direction.

As in FIG. 2, the electrode body 30 described above is stored within the container body 16 with the wound axis C coinciding with the height direction Z of the outer container 12 and in an orientation where one end surface of the electrode group 74, the positive electrode collecting tab group 32A, and the negative electrode collecting tab group 33A are located on the side of the lid 14. One end surface of the electrode group 74 faces the lid 14 at a predetermined distance. The positive electrode current collecting tab group 32A is located at one end of the longitudinal direction X of the electrode body 30 and faces the positive electrode terminal 20. The negative electrode current collecting tab group 33A is located at the other end of the electrode body 30 in the longitudinal direction X and faces the negative electrode terminal 21.

In the present embodiment, the positive electrode current collecting tab group 32A is divided into two tab groups in the stacking direction, in this example, the width direction Y. That is, the positive electrode current collecting tab group 32A is divided into a first tab group 32A1 including a plurality of positive electrode current collecting tabs 32 and a second tab group 32A2 including a plurality of positive electrode current collecting tabs 32. The first tab group 32A1 faces the second tab group 32A2 with a gap in the width direction Y. Extended ends of the first tab group 32A1 and extended ends of the second tab group 32A2 may be pinched together by a backup lead bent into a U-shape, respectively.

Similarly, the negative electrode current collecting tab group 33A is divided into a first tab group 33A1 including a plurality of negative electrode current collecting tabs 33 and a second tab group 33A2 including a plurality of negative electrode current collecting tabs 33. The first tab group 33A1 faces the second tab group 33A2 with a gap in the width direction Y. Extended ends of the first tab group 33A1 and extended ends of the second tab group 33A2 may be pinched together by a backup lead bent into a U-shape, respectively.

As in FIG. 2, the secondary battery 10 includes an insulator 36, positive electrode lead 40A, and negative electrode lead 40B provided in the space between the electrode body 30 and the lid 14 in the outer container 12. The insulator 36 is formed in the shape of a rectangular plate with approximately the same dimensions as the lid 14. The insulator 36 is positioned opposed to the inner surface of the lid 14. The insulator 36 has a pair of through holes T3 facing a pair of through holes T2 of the lid 14, respectively, and a through hole T5 facing the injection port 29.

The positive electrode lead 40A is disposed between the insulator 36 and the positive electrode current collecting tab 32, and electrically connects the positive electrode terminal 20 to the positive electrode current collecting tab 32. The negative electrode lead 40B is disposed between the insulator 36 and the negative electrode current collecting tab 33, and electrically connects the negative electrode terminal 21 to the negative electrode current collecting tab 33.

The positive electrode lead 40A is formed of a metal plate and integrally has a rectangular plate-shaped first joint portion 42a and a rectangular plate-shaped second joint portion 42b orthogonal to the first joint portion 42a. The first joint portion 42a has a length slightly shorter than half the length of the lid 14 in the longitudinal direction X and a width slightly shorter than the width of the lid 14 in the width direction Y. The first joint portion 42a is arranged such that a pair of long sides extend in the longitudinal direction X and are parallel and opposed to the lid 14. The first joint portion 42a has a through hole T4 for joining the connecting rod 20b of the positive electrode terminal 20 and a through hole T6 opposed to the injection port 29.

The second joint portion 42b extends from the bottom side of the first joint portion 42a almost perpendicular to the first joint portion 42a. The second joint portion 42b is located approximately in the center between a pair of long sides of the first joint portion 42a. The second joint portion 42b has the same length in the longitudinal direction X as the first joint portion 42a and a width in the height direction Z which is equal to or greater than the width of the first joint portion 42a. The second joint portion 42b extends from one end of the first joint portion 42a in the longitudinal direction X to the other end. Further, both sides of the second joint portion 42b form rectangular first and second joint surfaces S1 and S2, which are parallel and opposed to each other.

The negative electrode lead 40B has the same shape and dimensions as the positive electrode lead 40A. That is, the negative electrode lead 40B is formed of a metal plate and integrally includes a rectangular plate-shaped first joint portion 42a and a rectangular plate-shaped second joint portion 42b. The first joint portion 42a has a pair of long sides extending in the longitudinal direction X and is positioned parallel and opposed to the lid 14. The first joint portion 42a has only a through hole T4 for joining the connecting rod 21b of the negative electrode terminal 21. The second joint portion 42b extends from the bottom side of the first joint portion 42a almost perpendicular to the first joint portion 42a. The second joining portion 42b has rectangular first joining surface S1 and second joining surface S2, which are parallel and opposed to each other.

Note that, for example, aluminum, aluminum alloy, copper or copper alloy metal plates can be used as the metal plates forming the positive electrode lead 40A and negative electrode lead 40B.

The internal structure of the assembled secondary battery 10 will be described below.

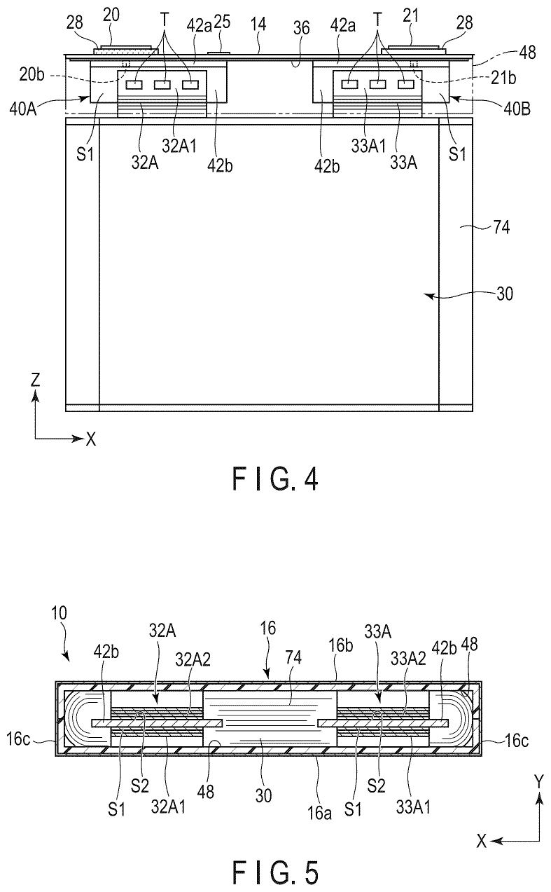

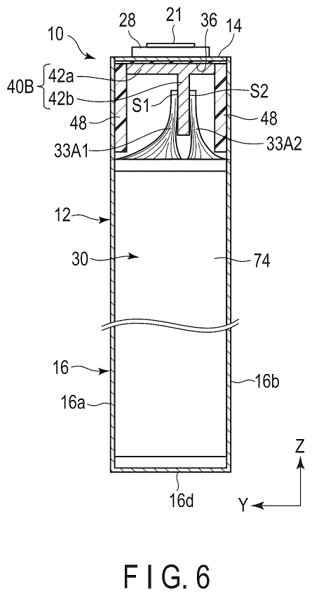

FIG. 4 is a front view of the secondary battery showing the container body 16 omitted, FIG. 5 is a cross-sectional view of the secondary battery, taken along line A-A of FIG. 1, and FIG. 6 is a cross-sectional view of the secondary battery, taken along line B-B in FIG. 1.

As in FIG. 4, the connecting rod 20b of the positive electrode terminal 20 is fitted into the through hole T4 of the first joint portion 42a of the positive electrode lead 40A through the through hole T1 of the gasket 28, through hole T2 of the lid 14, and through hole T3 of the insulator 36, and is joined to the first joint portion 42a by laser welding or ultrasonic bonding. As a result, the positive electrode terminal 20 is fixed to the outer surface of the lid 14 through the gasket 28, and is also electrically connected to the positive electrode lead 40A. The first joint portion 42a of the positive electrode lead 40A faces parallel to the inner surface of the lid 14 across the insulator 36 and extends in the longitudinal direction X from near the edge of the positive electrode terminal 20 side of the lid 14 to the center of the longitudinal direction X of the lid 14. The through hole T6 of the first joint portion 42a is aligned with the through hole T5 of the insulator 36 and the inlet 29 of the lid 14. The lid 14 and the positive electrode lead 40A are electrically insulated by the insulator 36.

The connecting rod 21b of the negative electrode terminal 21 is fitted into the through hole T4 of the first joint portion 42a of the negative electrode lead 40B through the through hole T1 of the gasket 28, through hole T2 of the lid 14, and through hole T3 of the insulator 36, and is joined to the first joint portion 42a by laser welding or ultrasonic bonding. As a result, the negative electrode terminal 21 is fixed to the outer surface of the lid 14 through the gasket 28, and is also electrically connected to the negative electrode lead 40B. The first joint portion 42a of the negative electrode lead 40B faces parallel to the inner surface of the lid 14 across the insulator 36 and extends in the longitudinal direction X from near the edge of the negative electrode terminal 21 side of the lid 14 to the center of the longitudinal direction X of the lid 14. The lid 14 and the negative electrode lead 40B are electrically insulated by the insulator 36.

As in FIGS. 4, 5, and 6, the second joint portion 42b of the negative electrode lead 40B extends approximately perpendicular to the first joint portion 42a and the lid 14, and also extends in the longitudinal direction X. The second joint portion 42b extends between the first tab group 33A1 and the second tab group 33A2 of the negative electrode current collecting tab group 33. In other words, the first joint surface S1 of the second joint portion 42b faces the first tab group 33A1 and the second joint surface S2 faces the second tab group 33A2.

The first tab group 33A1 is joined to the first joint surface S1 of the second joint portion 42b. The second tab group 33A2 is joined to the second joint surface S2 of the second joint portion 42b and is opposed to the first tab group 33A1 across the second joint portion 42b. As a result, the negative electrode lead 40B is electrically connected to the negative electrode tab group 32A.

As in FIGS. 4 and 5, the second joint portion 42b of the positive electrode lead 40A extends approximately perpendicular to the first joint portion 42a and the lid 14, and also extends in the longitudinal direction X. The second joint portion 42b extends between the first tab group 32A1 and the second tab group 32A2 of the positive electrode current collecting tab group 32A and is sandwiched between the first tab group 32A1 and the second tab group 32A2. The first joint surface S1 of the second joint portion 42b faces the first tab group 32A1 and the second joint surface S2 faces the second tab group 32A2.

The first tab group 32A1 is joined to the first joint surface S1 of the second joint portion 42b. The second tab group 32A2 is joined to the second joint surface S2 of the second joint portion 42b and is opposed to the first tab group 32A1 across the second joint portion 42b. As a result, the positive electrode lead 40A is electrically connected to the positive electrode current collecting tab group 32A.

Within the outer container 12, a rectangular frame-shaped insulating member 48 is provided between the electrode body 30 and the lid 14, surrounding the positive electrode lead 40A and the negative electrode lead 40B. The insulating member 48 is formed of an insulating material such as synthetic resin in the form of a sheet or plate having a predetermined thickness. In one example, the insulating member 48 is adhered to the inner surface of the container body 16 and covers the area between the edge of the upper opening side of the container body 16 and the end face of the electrode body 30 over the entire circumference. The positive electrode lead 40A and the negative electrode lead 40B are electrically insulated from the container body 16 by the insulating member 48.

Laser welding, ultrasonic joining, resistance welding, and other methods are used to join the aforementioned current-collecting tab groups to electrode leads. According to the present embodiment, the current-collecting tab group is joined to the electrode leads by ultrasonic bonding.

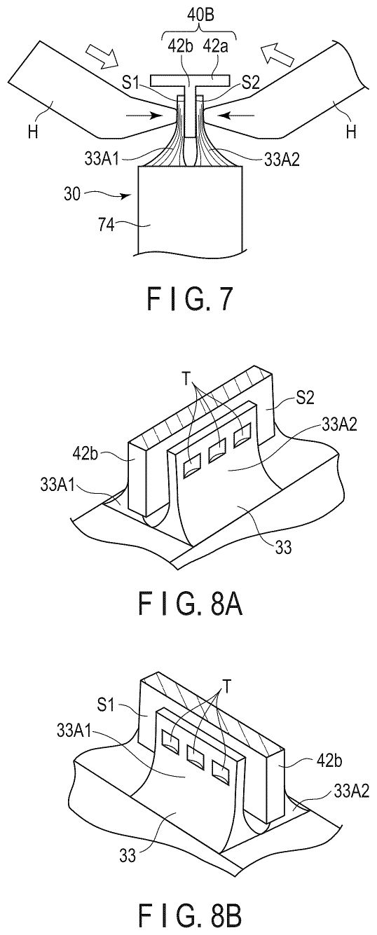

FIG. 7 schematically illustrates the joining process, and FIGS. 8A and 8B are perspective views of the joined current-collecting tab groups and electrode leads, respectively, viewed from different angles.

As in FIG. 7, in one example, with the second joint portion 42b of the negative electrode lead 40B sandwiched between the first and second tab groups 33A1 and 33A2, the dual head (a pair of horns H) of the ultrasonic bonding device is placed to sandwich the first tab group 33A1, the second joint portion 42b of the negative electrode lead 40B, and the second tab group 33A2 from both sides. One horn H contacts the outer surface side of the first tab group 33A1 and presses the first tab group 33A1 to the first joint surface S1 of the second joint portion 42b with a predetermined load. The other horn H contacts the outer surface side of the second tab group 33A2 and presses the second tab group 33A2 to the second joining surface S2 of the second joint portion 42b with a predetermined load. In this state, the pair of horns H are vibrated by ultrasonic waves in opposite phase. By applying the load and ultrasonic vibration to the bonding interface, the oxide film and contamination on the bonding interface are removed and the metal atoms are bonded to each other by inter-electronic forces. In other words, the first tab group 33A1 is joined to the first joint surface S1 and the second tab group 33A2 is joined to the second joint surface S2. In a single joint operation, both the first tab group 33A1 and the second tab group 33A2 are simultaneously joined to the negative electrode lead 40B.

The first tab group 32A1 and the second tab group 32A2 of the positive electrode current collecting tab group 32A are simultaneously joined to the first joint surface S1 and the second joint surface S2 of the second joint portion 42b of the positive electrode lead 40A by the same ultrasonic bonding method described above.

When the above ultrasonic bonding is used, horn marks (pressing marks of horns) T remain on the outer surface of the first tab group 33A1 and the second tab group 33A2, respectively, as shown in FIGS. 8A and 8B. In one example, horn marks (pressure marks) T consisting of three rectangular recesses aligned in the longitudinal direction X are left on the outer surface of each tab group. Similarly, horn marks (pressure marks) T remain on the first tab group 32A1 and the second tab group 32A2 of the positive electrode current collecting tab group 32A.

The first tab group 32A1 (33A1) and the second tab group 32A2 (33A2), which are divided in the thickness direction, may each include the same number of current-collecting tabs, or they may each include a different number of tabs.

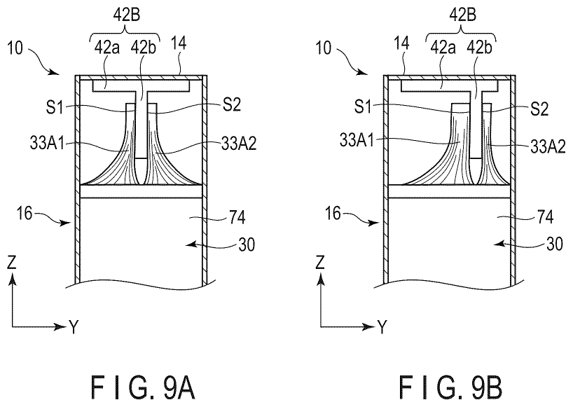

For example, as in FIG. 9A, when the first tab group 33A1 and the second tab group 33A2 each comprise the same number of current-collecting tabs, the second joint portion 42b of the negative electrode lead 40b is provided at approximately the center of the first joint portion 42a in the width direction Y and extends between the first tab group 33A1 and the second tab group 33A2.

As in FIG. 9B, when the first tab group 33A1 and the second tab group 33A2 are composed of different numbers of current-collecting tabs, for example, when the first tab group 33A1 is composed of more tabs than the second tab group 33A2, the second joint portion 42b of the negative electrode lead 40B is provided at a position shifted from the center of the first joint portion 42a in the width direction Y to the side of the second tab group 33A2 of a smaller number of tabs, and extends between the first tab group 33A1 and the second tab group 33A2.

The second joint portion 42b of the positive electrode lead 40A is also structured in the same manner as the second joint portion 42b of the negative electrode lead 40B above.

According to the secondary battery 10 of the first embodiment configured as above, the current collecting tab groups can be simultaneously bonded to both the first and second joint surfaces of the electrode leads, thereby simplifying the structure of the bonding part and the bonding work. In addition, in the first embodiment, the current collecting tab group is divided into multiple tab groups and each tab group is bonded to a common lead, which increases the bonding area between the current collecting tab and the lead and improves thermal conductivity. This allows for even higher current draw. At the same time, the increased joint area between the current collector tabs and leads makes it possible to improve the vibration resistance of the current collector tabs.

In summary, according to the first embodiment, a secondary battery which can simplify the work of bonding current collecting tabs can be provided.

Next, the secondary battery according to other embodiments will be described. In the other embodiments described below, the same parts and the same components as in the first embodiment described above will be referred to by the same reference numbers as in the first embodiment to omit or simplify their description, and the description will focus on the parts that differ from the first embodiment.

### Second Embodiment

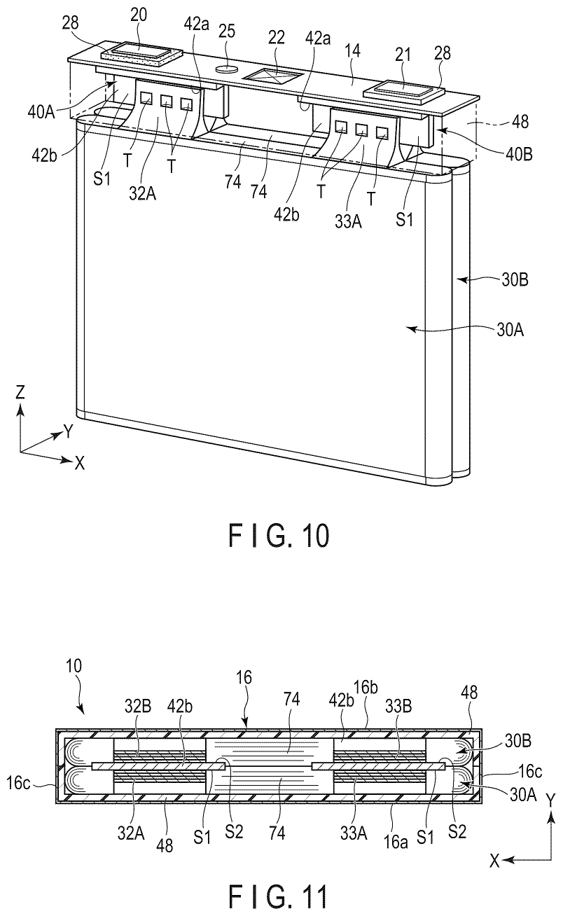

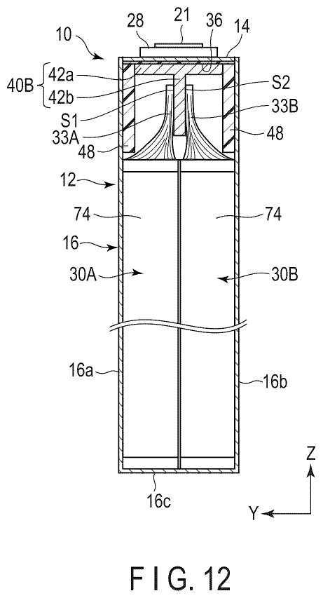

FIG. 10 is a perspective view of a secondary battery of a second embodiment, omitting the container body; FIG. 11 is a cross-sectional view of the secondary battery of the second embodiment, corresponding to FIG. 5; and FIG. 12 is a cross-sectional view of the secondary battery of the second embodiment, corresponding to FIG. 6.

As in the figures, the secondary battery 10 of the second embodiment includes a plurality of electrode bodies, e.g., two electrode bodies 30A and 30B, which are stored in an outer container 12.

The electrode body 30A is structured in the same manner as the electrode body 30 in the first embodiment described above. However, the electrode body 30A is formed more flatly than electrode body 30 and has a thickness of about ½ of the thickness of electrode body 30 in the width direction Y. The electrode body 30A has an electrode group 74 and a positive electrode current collecting tab group 32A and a negative electrode current collecting tab group 33A extending in the height direction Z from one end of the axial direction of the electrode group 74. The positive electrode current collecting tab group 32A includes a plurality of positive electrode current collecting tabs stacked in the thickness direction. The negative electrode current collecting tab group 33A includes a plurality of negative electrode current collecting tabs stacked in the thickness direction.

The positive electrode current collecting tab group 32A is located at one end of the electrode body 30A in the longitudinal direction X. The negative electrode current collecting tab 33A is located at the other end of the electrode body 30A in the longitudinal direction X. Thus, the positive electrode current collecting tab group 32A and the negative electrode current collecting tab group 33A extend in the same direction from one end of the electrode group 74 and are located apart from each other in the longitudinal direction X of the electrode body 30A.

The electrode body 30A structured as above is stored within the container body 16 in an orientation in which the wound axis line is aligned with the height direction Z of the outer container 12 and the positive electrode current collecting tab group 32A and negative electrode current collecting tab group 33A are located on the side of the lid 14. One end surface of the electrode group 74 faces the lid 14 at a distance.

The electrode body 30B is structured in the same manner as the electrode body 30A. The electrode body 30B has an electrode group 74, a positive electrode current collecting tab group 32B and a negative electrode current collecting tab group 33B extending from the electrode group 74 in the height direction Z. The positive electrode current collecting tab group 32B includes a plurality of positive electrode current collecting tabs stacked in the thickness direction. The negative electrode current collecting tab group 33B includes a plurality of negative electrode current collecting tabs stacked in the thickness direction.

The positive electrode current collecting tab group 32B is located at one end side of the electrode body 30B in the longitudinal direction X. The negative electrode current collecting tab group 33B is located at the other end of the electrode body 30A in the longitudinal direction X. The positive electrode current collecting tab group 32B and the negative electrode current collecting tab group 33B extend in the same direction from one end of the electrode group 74 and are positioned apart from each other in the longitudinal direction X of the electrode body 30A.

The electrode body 30B structured as above is stored within the container body 16 with the wound axis line coinciding with the height direction Z of outer container 12 and in an orientation in which positive electrode current collecting tab group 32B and the negative electrode current collecting tab 33B are located on the side of the lid 14, and is arranged side by side with the electrode body 30A in the width direction Y. The positive electrode current collecting tab group 32B is spaced apart in the width direction Y and is opposed to the positive electrode current collecting tab group 32A in the width direction Y. The negative electrode current collecting tab group 33B is spaced apart in the width direction Y and faces the negative electrode current collecting tab group 33A in the width direction Y.

As in FIGS. 10, 11, and 12, the second joint portion 42b of the negative electrode lead 40B extends almost perpendicular to the first joint portion 42a and the lid 14, and also extends in the longitudinal direction X. The second joint portion 42b extends between the negative electrode current collecting tab group 33A of the electrode body 30A and the negative electrode current collecting tab group 33B of the electrode body 30B. In other words, the first joint surface S1 of the second joint portion 42b faces the negative electrode current collecting tab group 33A, and the second joint surface S2 faces the negative electrode current collecting tab group 33B.

The negative electrode current collecting tab group 33A is joined to the first joint surface S1 of the second joint portion 42b. The negative electrode current collecting tab group 33B is joined to the second joint surface S2 of the second joint portion 42b and faces the negative electrode current collecting tab group 33A across the second joint portion 42b. As a result, the negative electrode lead 40B is electrically connected to the negative electrode current collecting tab groups 33A and 33B.

As in FIGS. 10 and 11, the second joint portion 42b of the positive electrode lead 40A extends approximately perpendicular to the first joint portion 42a and the lid 14, and also extends in the longitudinal direction X. The second joint portion 42b extends between the positive electrode collector tab group 32A of the electrode body 30A and the positive electrode collector tab group 32B of the electrode body 30B. The first joint surface S1 of the second joint portion 42b faces the positive electrode current collecting tab group 32A, and the second joint surface S2 faces the positive electrode current collecting tab group 32B.

The positive electrode current collecting tab group 32A is joined to the first joint surface S1 of the second joint portion 42b. The positive electrode current collecting tab group 32B is joined to the second joint surface S2 of the second joint portion 42b and faces the positive electrode current collecting tab group 32A across the second joint portion 42b. As a result, the positive electrode lead 40A is electrically connected to the positive electrode current collecting tab groups 32A and 32B.

In the second embodiment, the same ultrasonic bonding as in the first embodiment is used to bond the current-collecting tab group to the leads.

In other words, with the positive electrode current collecting tab group 32A, the second joint portion 42b of the positive electrode lead, and the positive electrode current collecting tab group 32B sandwiched between a pair of horns H, the positive electrode current collecting tab group 32A and the positive electrode current collecting tab group 32B are simultaneously ultrasonically joined to the first joint surface S1 of the second joint portion 42b, and to the second joint surface S2 of the second joint portion 42b, respectively. In a single joint operation, both of the positive electrode current collecting tab groups 32A and 32B are simultaneously joined to the positive electrode lead 40A.

Similarly on the negative electrode side, with the negative electrode current collection tab group 33A, the second joint portion 42b of the negative electrode lead, and the negative electrode current collection tab group 33B sandwiched between a pair of horns H, the negative electrode current collection tab group 33A and the negative electrode current collection tab group 33B are simultaneously ultrasonically joined to the first joint surface S1 of the second joint portion 42b and to the second joint surface S2 of the second joint portion 42b, respectively. In a single bonding operation, both negative electrode current collecting tab groups 33A and 33B are simultaneously bonded to the negative electrode lead 40B.

Horn marks (pressure marks) T remain on the outer surface of the positive electrode collector tab groups 32A and 32B and the outer surface of the negative electrode collector tabs 33A and 33B, respectively.

In the second embodiment, the other structure of the secondary battery 10 is the same as that of the secondary battery 10 of the first embodiment.

The secondary battery 10 of the second embodiment structured as above also has the same effects as the secondary battery of the first embodiment. According to the second embodiment, by providing a plurality of electrode bodies, the capacity of the secondary battery can be increased. Furthermore, according to the second embodiment, by joining a plurality of current-collecting tab groups of the plurality of electrode bodies to both sides of a common lead, it is possible to simplify the structure of joining the current-collecting tabs and the lead, improve the weight energy density of the secondary battery, and simplify the manufacturing process.

### Third Embodiment

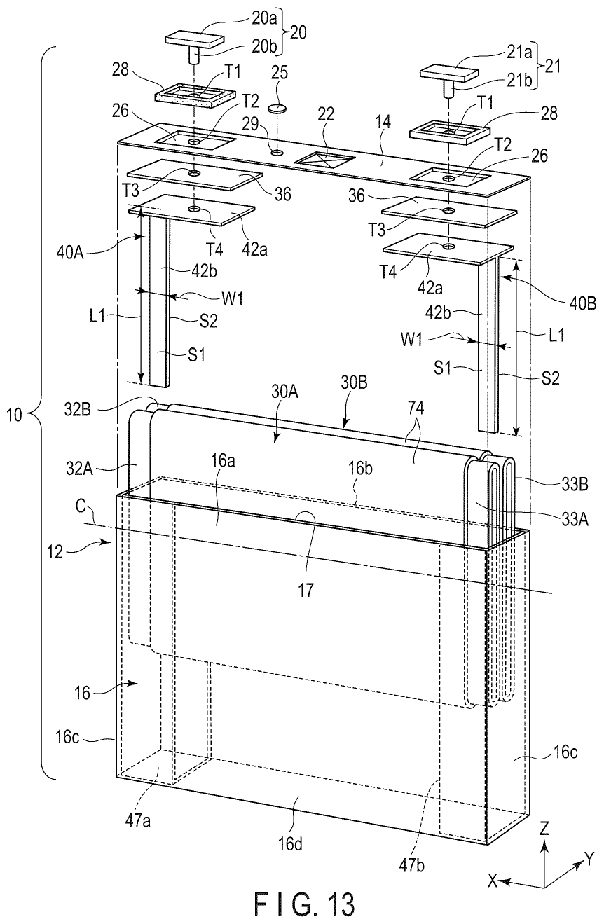

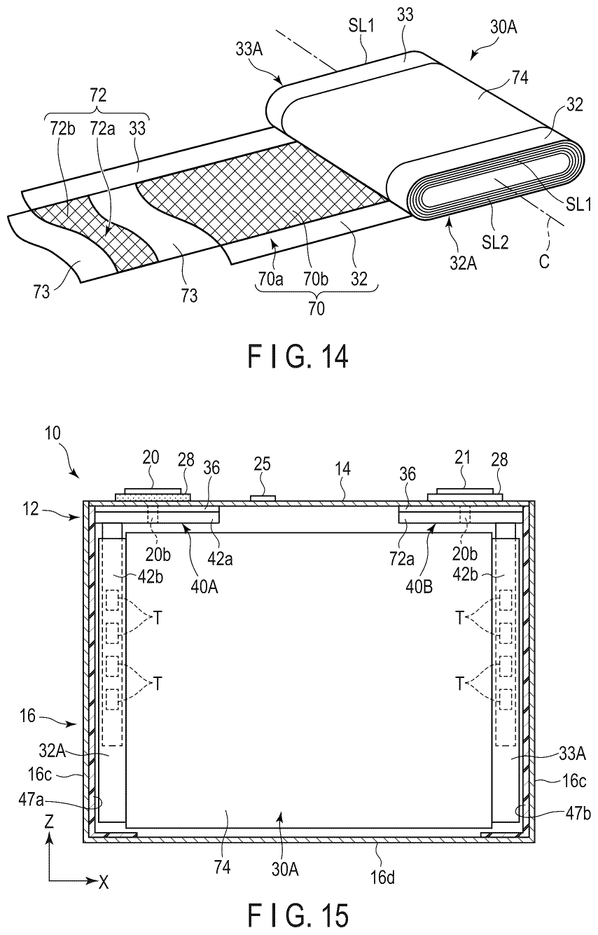

FIG. 13 is a perspective view of the secondary battery of the third embodiment in a disassembled manner, and FIG. 14 is a perspective view of the electrode body of the third embodiment in a partially expanded manner.

As in FIG. 13, the secondary battery 10 of the third embodiment has a plurality of electrode bodies, for example, two electrode bodies 30A and 30B which are stored in the outer container 12. As each electrode body, a so-called horizontal tab type in which a positive electrode current collecting tab and a negative electrode current collecting tab extend in opposite directions from a group of electrodes is used, and it is also a wound type electrode body.

A representative example of electrode body 30A will be described below. As in FIG. 14, electrode body 30A is formed into a flat rectangular shape by spirally winding a sheet-shaped positive electrode plate 70 and negative electrode plate 72, respectively, around the winding axis C with a sheet-shaped separator 73 interposed therebetween, and further compressing them in the radial direction such that the cross-sectional shapes thereof are almost the same rectangular shape, and thus, the electrode group 74 is formed in a flat rectangular shape. On the outermost layer (outermost circumference) of the electrode group 74, a separator 73 is placed.

The positive electrode plate 70 includes, for example, a strip-shaped positive electrode current collector 70a formed of metal foil and a strip-shaped positive electrode active material layer 70b formed on at least one side of the positive electrode current collector 70a. The positive electrode active material layer 70b has a width smaller than the width of the positive electrode current collector 70a, wherein one side edge is aligned with one side edge of the positive electrode current collector 70a, and the other side edge extends parallel to the other side edge of the positive electrode current collector 70a at a fixed interval. The portion of the positive electrode current collector 70a which does not carry the positive electrode active material layer 70b forms the positive electrode current collection tab 32 of the positive electrode plate 70. The positive electrode current collecting tab 32 has a constant width in a direction parallel to the wound axis C and extends continuously along the other side edge of the positive electrode current collector 70a.

The negative electrode plate 72 includes a strip-shaped negative electrode collector 72a formed of metal foil and a strip-shaped negative electrode active material layer 72b formed on at least one side of the negative electrode collector 72a. The negative electrode active material layer 72b has a width smaller than the width of the negative electrode current collector 72a and is also formed to be approximately the same width as the positive electrode active material layer 70b. The negative electrode active material layer 72b has one side edge aligned with one side edge of the negative electrode current collector 72a and the other side edge extends parallel to the other side edge of the negative electrode current collector 72a at a fixed distance. The portion of the negative electrode collector 72a which does not carry the negative electrode active material layer 72b forms the negative electrode current collection tab 33 of the negative electrode plate 72. The negative electrode current collecting tab 33 has a constant width in a direction parallel to the wound axis C and extends continuously along the other side edge of the negative electrode collector 72a.

The negative electrode plate 72 is displaced from the positive electrode plate 70 by the above predetermined interval in one direction parallel to the winding axis C. As a result, the negative electrode active material layer 72b of the negative electrode plate 72 is aligned with and facing the positive electrode active material layer 70b of the positive electrode plate 70, and the negative electrode current collecting tab 33 does not overlap with the positive electrode plate 70 but extends in the opposite direction to the positive electrode current collecting tab 32. Similarly, the positive electrode current collecting tab 32 of the positive electrode plate 70 extends in the opposite direction of the negative electrode current collecting tab 33 without overlapping the negative electrode plate 72.

Each of the separators 73 is formed to be approximately the same width as the width of the positive electrode active material layer 74a and the negative electrode active material layer 74b. Each of the separators 73 is located to be opposed to only the positive electrode active material layer 74a and the negative electrode active material layer 74b, and does not overlap the positive electrode collector tab 32 and the negative electrode collector tab 33.

Note that, the current collectors and current collecting tabs of the positive electrode plate 70 and negative electrode plate 72 may be formed, for example, by punching out a metal foil. The thickness of the metal foil, that is, the thickness per current collecting tab, should be between 5 and 50 μm. A thickness of 5 μm or more prevents the collector and current collecting tabs from breaking during manufacturing and enables high current collection efficiency. It is also possible to avoid dissolution of the current collector tabs when a large current is applied. By reducing the thickness to 50 μm or less, the number of laps constituting the electrode body can be increased while reducing the increase in the thickness of the electrode body. Preferably, the thickness of the metallic foil is between 10 and 20 μm. The material of the metal foil can be aluminum, aluminum alloy, copper or copper alloy, for example, although it can vary depending on the type of active material used for the positive and negative electrodes.

By overlapping and winding the positive electrode plate 70, separator 73, and negative electrode plate 72 described above, the positive electrode current collecting tabs 32 are also wound around the winding axis C and sequentially stacked in the thickness direction to form a ring-shaped positive electrode current collecting tab group 32A. The positive electrode current collecting tab group 32A extends from one end face of the electrode group 74 in the axial direction in one direction parallel to the wound axis C. In the present embodiment, the positive electrode current collecting tab group 32A is formed in a flat track shape including a pair of linear stripe portions SL1 and SL2 facing each other with a gap therebetween.

Similarly, the negative electrode current collecting tabs 33 are wound around the winding axis C and sequentially stacked in the thickness direction to form a ring-shaped negative electrode current collecting tab group 33A. The negative electrode current collecting tab group 33A extends from the other end face of the electrode group 74 in the axial direction in the opposite direction parallel to the wound axis C, that is, opposite to the direction in which the positive electrode current collecting tab group 32A extends. In the present embodiment, the negative electrode current collecting tab group 33A is formed in a flat track shape including a pair of linear stripe portions SL1 and SL2 facing each other with a gap therebetween.

The other electrode body 30B is structured in the same manner as the electrode body 30A described above. That is, the electrode body 30B has the electrode group 74 formed in a flat rectangular shape, positive electrode current collecting tab group 32B extending from one end face of electrode group 74 in the axial direction parallel to the wound axis C, and negative electrode current collecting tab group 33B extending from the other end face of electrode group 74 in the opposite direction parallel to the wound axis C.

As in FIG. 13, the electrode body 30A structured as above is stored in the container body 16 with the wound axis C coinciding with the longitudinal direction X of the outer container 12, and with the positive electrode current collecting tab group 32A and the negative electrode current collecting tab group 33A extending in the height direction Z, respectively. The positive electrode current collecting tab group 32A and the negative electrode current-collecting tab group 33A are located on the side of the positive electrode terminal 20 and the negative electrode terminal 21, respectively.

The electrode body 30B is stored in the container body 16 with the wound axis C coinciding with the longitudinal direction X of the outer container 12 and in an orientation in which the positive electrode current collecting tab group 32A and the negative electrode current collecting tab group 33A extend in the height direction Z, respectively, and is arranged alongside electrode body 30A in the width direction Y. The positive electrode current collecting tab group 32B and the negative electrode current collecting tab group 33B are arranged on the side of the positive electrode terminal 20 and the negative electrode terminal 21, respectively. The positive electrode current collecting tab group 32B faces the positive electrode current collecting tab group 32A of the electrode body 30A approximately parallel to each other with a gap in the width direction Y. The negative electrode current collecting tab group 33B faces approximately parallel to the negative electrode current collecting tab group 33A of the electrode body 30A, with a gap in the width direction Y.

As in FIG. 13, insulating members 47a and 47b are provided inside the container body 16 to electrically insulate between the container body 16 and the positive electrode current collecting tab groups 32A and 32B, and between the container body 16 and the negative electrode current collecting tab groups 33A and 33B, respectively. In one example, the insulating members 47a and 47b are each formed from an insulating material such as synthetic resin in the form of a sheet or plate having a predetermined thickness. The insulating member 47a is adhered to the inner surface of one side wall 16c of the inner surface of the container body 16, and covers around the positive electrode current collector tab groups 32A and 32B. The insulating member 47b is adhered to the inner surface of the inner surface of the container body 16 on the side of the other side wall 16c and covers the periphery of the negative electrode current collecting tab groups 33A and 33B.

As in FIG. 13, the secondary battery 10 includes two insulators 36, positive electrode lead 40A and negative electrode lead 40B provided in the space between the electrode bodies 30A and 30B and the lid 14 in the outer container 12. Each insulator 36 is formed in the shape of a rectangular plate. One insulator 36 is positioned opposed to the inner surface of the lid 14 at a location opposed to the positive electrode terminal 20. The other insulator 36 is disposed opposed to the inner surface of the lid 14 at a position opposed to the negative electrode terminal 21. The insulator 36 has a through hole T3 which is opposed to a pair of through holes T2 of the lid 14, respectively.

The positive electrode lead 40A is disposed between the insulator 36 and the positive electrode current collecting tab groups 32A and 32B, and electrically connects the positive electrode terminal 20 to the positive electrode current-collecting tab groups 32A and 32B. The negative electrode lead 40B is disposed between insulator 36 and the negative electrode current collecting tab groups 33A and 33B, and electrically connects negative electrode terminal 21 to negative electrode current collecting tab groups 33A and 33B.

The positive electrode lead 40A is formed of a metal plate and has a rectangular plate-shaped first joint portion 42a and an elongated rectangular plate-shaped second joint portion 42b which is orthogonal to the first joint portion 42a in one piece. The first joint portion 42a has a length slightly shorter than half the length of the lid 14 in the longitudinal direction X and a width slightly shorter than the width of the lid 14 in the width direction Y. The first joint portion 42a has a pair of long sides extending in the longitudinal direction X and is positioned parallel and opposite to the lid 14 with the insulator 36 therebetween. The first joint portion 42a has a through hole T4 for joining the connecting rod 20b of the positive electrode terminal 20.

The second joint portion 42b extends from the bottom side of the first joint portion 42a in the height direction Z approximately perpendicular to the first joint portion 42a. The second joint portion 42b is located at one end of the first joint portion 42a in the longitudinal direction X, here on the side of the sidewall 16c, and approximately between a pair of long sides of the first joint portion 42a. The second joint portion 42b has a width W1 in the longitudinal direction X and a length L1 in the height direction Z. The width W1 is slightly smaller than the width in the longitudinal direction X of the collector tab groups 32A and 33A of the electrode bodies 30A and 30B described above. The length L1 is slightly shorter than the length in the height direction Z of the current collecting tab groups 32A and 33A. Both sides of the second joint portion 42b form a first joint surface S1 and a second joint surface S2 opposed thereto.

The negative electrode lead 40B has the same shape and dimensions as the positive electrode lead 40A. That is, the negative electrode lead 40B is formed of a metal plate and has a rectangular plate-shaped first joint portion 42a and an elongated rectangular plate-shaped second joint portion 42b in one piece. The first joint portion 42a has a pair of long sides extending in the longitudinal direction X and is positioned parallel and opposed to the lid 14 with the insulator 36 therebetween. The first joint portion 42a has a through hole T4 for joining the connecting rod 21b of the negative electrode terminal 21. The second joint portion 42b extends from one end of the first joint portion 42a in the longitudinal direction X, here on the side of the side wall 1c, in the height direction Z approximately perpendicular to the first joint portion 42a. The second joint portion 42b has rectangular first and second joint surfaces S1 and S2, which are parallel and opposite to each other.

Note that, for example, aluminum, aluminum alloy, copper or copper alloy metal plates can be used as the metal plates forming the positive electrode lead 40A and negative electrode lead 40B.

The internal structure of the assembled secondary battery 10 will be described below.

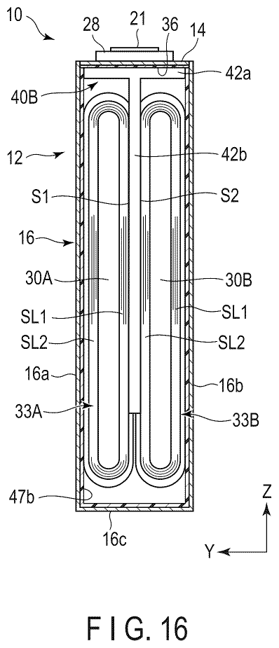

FIG. 15 is a cross-sectional view of a secondary battery of the third embodiment, and FIG. 16 is a cross-sectional view of a secondary battery of the third embodiment, corresponding to FIG. 6.

As in FIG. 15, the connecting rod 20b of the positive electrode terminal 20 is fitted into the through hole T4 of the first joint portion 42a of the positive electrode lead 40A through the through hole T1 of the gasket 28, through hole T2 of the lid 14, and through hole T3 of the insulator 36, and is joined to the first joint portion 42a by laser welding or ultrasonic bonding. As a result, the positive electrode terminal 20 is fixed to the outer surface of the lid 14 through the gasket 28, and is also electrically connected to the positive electrode lead 40A. The first joint portion 42a of the positive electrode lead 40A faces parallel to the inner surface of the lid 14 across the insulator 36 and extends in the longitudinal direction X from near the edge of the positive electrode terminal 20 side of the lid 14 to the center of the longitudinal direction X of the lid 14. The lid 14 and positive electrode lead 40A are electrically insulated by the insulator 36.

The connecting rod 21b of the negative electrode terminal 21 is fitted into the through hole T4 of the first joint portion 42a of the negative electrode lead 40B through the through hole T1 of the gasket 28, through hole T2 of the lid 14, and through hole T3 of the insulator 36, and is joined to the first joint portion 42a by laser welding or ultrasonic bonding. As a result, the negative electrode terminal 21 is fixed to the outer surface of the lid 14 through the gasket 28, and is also electrically connected to the negative electrode lead 40B. The first joint portion 42a of the negative electrode lead 40B faces parallel to the inner surface of the lid 14 across the insulator 36 and extends in the longitudinal direction X from near the edge of the negative electrode terminal 21 side of the lid 14 to the center of the longitudinal direction X of the lid 14. The lid 14 and the negative electrode lead 40B are electrically insulated by the insulator 36.

As in FIGS. 15 and 16, the second joint portion 42b of the negative electrode lead 40B extends almost perpendicular to the first joint portion 42a and the lid 14 and between the negative electrode current collecting tab group 33A of the electrode body 30A and the negative electrode current collecting tab group 33B of the electrode body 30B. As a result, the second joint portion 42b is sandwiched between the negative electrode current collecting tab group 33A and the negative electrode current collecting tab group 33B. In one example, the second joint portion 42b is sandwiched between the linear stripe portion SL1 of the negative electrode current collecting tab group 33A and the linear stripe portion SL2 of the negative electrode current collecting tab group 33B. The first joint surface S1 of the second joint portion 42b faces the linear stripe portion SL1 of the negative electrode current collecting tab group 33A, and the second joint surface S2 faces the linear stripe portion SL2 of the negative electrode current collecting tab group 33B.

The linear stripe portion SL1 of the negative electrode current collecting tab group 33A is joined to the first joint surface S1 of the second joint portion 42b. The linear stripe portion SL2 of the negative electrode current collecting tab group 33B is joined to the second joint surface S2 of the second joint portion 42b and faces the linear stripe portion SL1 of the negative electrode current collecting tab group 33A across the second joint portion 42b. As a result, the negative electrode lead 40B is electrically connected to the negative electrode current collecting tab groups 33A and 33B.

As in FIG. 15, the second joint portion 42b of the positive electrode lead 40A extends almost perpendicular to the first joint portion 42a and the lid 14, and extends between the positive electrode current collecting tab group 32A of the electrode body 30A and the positive electrode current collecting tab group 32B of the electrode body 30B. The second joint portion 42b is sandwiched between the positive electrode current collecting tab group 32A and the positive electrode current collecting tab group 32B. In one example, as on the negative electrode side, the second joint portion 42b is sandwiched between the linear stripe portions SL1 of the positive electrode current collecting tab group 32A and SL2 of the positive electrode current collecting tab group 32B (see FIG. 14 for linear stripe portions SL1 and SL2). As a result, the first joining surface S1 of the second joint portion 42b faces the linear stripe portion SL1 of the positive electrode current collecting tab group 32A and the second joining surface S2 faces the linear stripe portion SL2 of the positive electrode current collecting tab group 32B.

The linear strip portion SL1 of the positive electrode current collecting tab group 32A is joined to the first joint surface S1 of the second joint portion 42b. The linear stripe portion SL2 of the positive electrode current collecting tab group 32B is joined to the second joint surface S2 of the second joint portion 42b and is opposed to the linear stripe portion SL1 of the positive electrode current collecting tab group 32A across the second joint portion 42b. As a result, the positive electrode lead 40A is electrically connected to the positive electrode current collecting tab groups 32A and 32B.

In the third embodiment, ultrasonic bonding similar to the first embodiment is used to join the current collecting tab group to the leads.

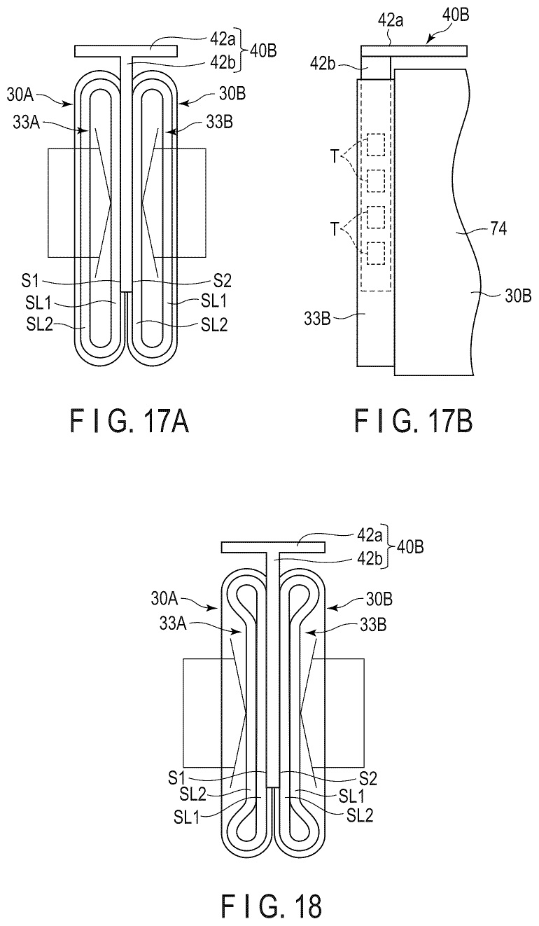

FIGS. 17A and 17B schematically show the joint process and the joint state of the current-collecting tab group and electrode leads, respectively, of the third embodiment.

As in FIGS. 17A, with the linear stripe portion SL1 of the negative electrode current collecting tab group 33A, second joint portion 42b of the negative electrode lead 40B, and linear stripe portion SL2 of the negative electrode current collecting tab group 33B sandwiched between a pair of horns, the linear stripe portion SL1 and the linear stripe portion SL2 are simultaneously ultrasonically joined to the first joint surface S1 of the second joint portion 42b and the second joint surface S2 of the second joint portion 42b, respectively. In a single joining operation, both of the negative electrode current collecting tab groups 33A and 33B are simultaneously joined to the negative electrode lead 40B. The side of the positive electrode current collecting tab group is also joined to the positive electrode lead 40A by the same ultrasonic joint process.

The same applies to the positive electrode side, and that is, with the linear stripe portion SL1 of the positive electrode current collection tab group 32A, second joint portion 42b of the positive electrode lead 40A, and linear stripe portion SL2 of the positive electrode current collection tab group 32B sandwiched between a pair of horns, the linear stripe portion SL1 and the linear stripe portion SL2 are simultaneously ultrasonically joined to the first joint surface S1 of the second joint portion 42b and the second joint surface S2 of the second joint portion 42b, respectively.

As in FIG. 17b, the linear strips SL1 and SL2 joined to the second joint surface 42b each leave horn marks (pressure marks) T. In one example, four rectangular horn marks T remain, each rectangular in shape, aligned in the longitudinal direction of the current-collecting tab group.

The secondary battery 10 of the third embodiment structured as above also has the same effects as the secondary battery of the first embodiment. According to the third embodiment, by providing a plurality of electrode bodies, it is possible to increase the capacity of the secondary battery. Furthermore, according to the third embodiment, it is possible to simultaneously bond a plurality of current collecting tab groups of a plurality of electrode bodies to both sides of a common lead, simplifying the structure of bonding current-collecting tabs and leads and simplifying the manufacturing process. In addition, the electrode leads need only have one second joint portion for two electrode bodies, simplifying and downsizing the electrode leads. The miniaturization of the electrode leads can improve the weight energy density of the secondary battery.

Next, a modification of the third embodiment will be described.

### (First Modification)

FIG. 18 schematically illustrates a joint process of a current collecting tab group and an electrode lead of the secondary battery of a first modification.

As in the figure, in the first modification, with the linear stripe portions SL1 and SL2 of the negative electrode current collection tab group 33A, second joint portion 42b of the negative electrode lead 40B, and straight stripe portions SL1 and SL2 of the negative electrode current collection tab group 33B sandwiched between a pair of horns, each horn simultaneously ultrasonically bonds both the linear stripe portions SL1 and SL2 to the second joint portion 42b of the first joint surface S1, and both the linear stripe portions SL1 and SL2 to the second joint surface S2 of the second joint portion 42b. In a single joining operation, both of the negative electrode current collecting tab groups 33A and 33B are simultaneously joined to the negative electrode lead 40B. The side of the positive electrode current collecting tab group is also joined to the positive electrode lead 40A by a similar ultrasonic bonding process.

According to the first modification, by joining both linear strips of the current collecting tab group to the electrode leads, the joint area of the current collecting tabs and the leads is increased, and thermal conductivity is improved. This enables even higher current extraction.

### (Second Modification)

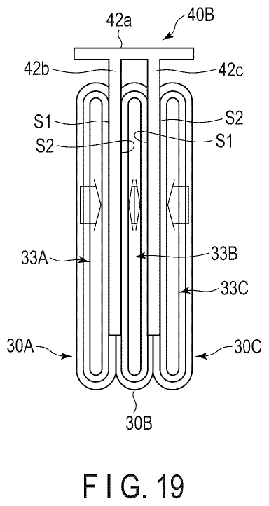

FIG. 19 schematically shows the structure of electrode body and electrode leads of a secondary battery of a second modification, and a process of joining a current collecting tab group to the electrode leads.

As in the figure, according to the second modification, the secondary battery includes three electrode bodies 30A, 30B, and 30C. The electrode bodies 30A, 30B, and 30C are formed and arranged side by side in the thickness direction, in the same configuration, shape, and dimensions, respectively. The electrode lead, in one example, the negative electrode lead 40B, has a first joint portion 42a and two second joint portions 42b and 42c, each extending almost vertically from the first joint portion 42a and facing parallel to each other at a distance. Each of the second joint portions 42b and 42c has a first joint surface S1 and a second joint surface S2 facing each other.

One second joint portion 42b is sandwiched between the negative electrode current collecting tab group 33A of the electrode body 30A and the negative electrode current collecting tab group 33B of the electrode body 30B. The negative electrode current collecting tab group 33A is joined to the first joint surface S1 of the second joint portion 42b, and the negative electrode current collecting tab group 33B is joined to the second joint surface S2, facing the negative electrode current collecting tab group 33A across the second joint portion 42b.

The other second joint portion 42c is sandwiched between the negative electrode current collecting tab group 33B of the electrode body 30B and the negative electrode current collecting tab group 33C of the electrode body 30C. The negative electrode current collecting tab group 33B is joined to the first joint surface S1 of the second joint portion 42c, and the negative electrode current collecting tab group 33C is joined to the second joint surface S2 of the second joint portion 42c, facing the negative electrode current collecting tab group 33B across the second joint portion 42c.

Ultrasonic bonding similar to the third embodiment described above is used to join each of the second joints portions 42b and 42c to the negative electrode collector tab group.

According to the second modification of the above structure, the secondary battery can be increased in capacity by providing multiple electrode bodies. In addition, a plurality of current collecting tab groups of the plurality of electrode bodies can be simultaneously bonded to both sides of a common lead, simplifying the structure of bonding the current collecting tabs to the lead and simplifying the manufacturing process. Furthermore, the electrode leads need only have one second joint portion for each of the two electrode bodies, allowing for simplification and downsizing of the electrode leads.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the electrode body is not limited to the so-called wound type electrode body, in which electrode plates are wound around each other, but may also be applied to the so-called stacked type electrode body, which includes a plurality of electrode plates stacked in the thickness direction. The forming material, shape, size, etc., of the elements constituting the secondary battery are not limited to the above-described embodiments, but can be changed in various ways as needed.

What is claimed is:

1. A secondary battery comprising:
an outer container with a lid;
an electrode body including an electrode group with a positive electrode plate and a negative electrode plate, a positive electrode current collecting tab group with a plurality of positive electrode current collecting tabs extending from the electrode group, and a negative electrode current collecting tab group with a plurality of negative electrode current collecting tabs extending from the electrode group, the electrode body stored in the outer container;
a pair of output terminals on the lid;
a positive electrode lead having a first joint portion connected to one of the output terminals and a second joint portion connected to the positive electrode current collecting tab group, the positive electrode lead electrically connecting the positive electrode current collecting tab group to the output terminals; and
a negative electrode lead having a first joint portion connected to the other output terminal and a second joint portion connected to the negative electrode current collecting tab group, the negative electrode lead electrically connecting the negative electrode current collecting tab group to the output terminal, wherein
the second joint portion has a first joint surface and a second joint surface opposing each other, and a part of current collector tab groups of the same polarity is joined to the first joint surface, and another part of the group of current collector tabs of the same polarity is joined to the second joint surface and opposing the part of the current collector tab groups across the second joint portion.

2. The secondary battery of claim 1, wherein
the positive electrode current collecting tab group is divided to a first tab group with a plurality of positive electrode current collecting tubs and a second tab group with a plurality of positive electrode current collecting tubs, in which the first tab group is joined to the first joint surface of the positive lead and the second tab group is connected to the second joint surface of the positive lead while opposing the first tab group with the second joint portion interposed therebetween, and
the negative electrode current collecting tub group is divided to a first tab group with a plurality of negative electrode current collecting tabs and a second tab group with a plurality of negative electrode current collecting tabs, in which the first tab group is connected to the first joint surface of the negative electrode lead and the second tab group is connected to the second joint surface of the negative electrode lead while opposing the first tab group with the second joint portion interposed therebetween.

3. The secondary battery of claim 2, wherein
the first tab group and the second tab group include the same number of current collecting tabs.

4. The secondary battery of claim 2, wherein
the first tab group and the second tab group include different numbers of current collecting tabs.

5. The secondary battery of claim 2, wherein
the first tab group and the second tab group each have a horn pressure mark.

6. The secondary battery of claim 1, wherein
the positive electrode current collecting tab group and the negative electrode current collecting tab group extend from one end side of the electrode group in the same direction.

7. The secondary battery of claim 1, wherein
the electrode body includes a first electrode body including an electrode group and a first positive electrode current collecting tab group and a first negative electrode current collecting tab group extending from the electrode group, the first electrode body stored in the outer container, and
a second electrode body including an electrode group and a second positive electrode current collecting tab group and a second negative electrode current collecting tab group, the second electrode body stored in the outer container while facing the first electrode body, wherein
the first positive electrode current collecting tab group is joined to the first joint surface of the positive electrode lead, and the second positive electrode current collecting tab group is joined to the second joint surface of the positive electrode lead while opposing the first positive electrode current collecting tab group with the second joint portion interposed therebetween, and
the first negative electrode current collecting tab group is joined to the first joint surface of the negative electrode lead, and the second negative electrode current collecting tab group is joined to the second joint surface of the positive electrode lead while opposing the first negative electrode current collecting tab group with the second joint portion interposed therebetween.

8. The secondary battery of claim 7, wherein
the first positive electrode current collecting tab group and the second positive electrode current collecting tab group each have a horn pressure mark, and
the first negative electrode current collecting tab group and the second negative electrode current collecting tab group each have a horn pressure mark.

9. The secondary battery of claim 7, wherein
in each of the first electrode body and the second electrode body, the electrode group is structured by the positive electrode plate and the negative electrode plate wound about a wound axis, and the positive electrode current collecting tab group and the negative electrode current collecting tab group extend from one end of the electrode group in the axis direction to the same direction.

10. The secondary battery of claim 7, wherein
in each of the first electrode body and the second electrode body, the electrode group is structured by the positive electrode plate and the negative electrode plate wound about a wound axis, and the positive electrode current collecting tab group extends in the axis direction from one end of the electrode group in the axis direction while the negative electrode current collecting tab group extends in the direction opposite to the positive electrode current collecting tab group from the other end of the electrode group in the axis direction.

11. The secondary battery of claim 10, wherein
the first positive electrode current collecting tab group includes a pair of linear stripe portions facing each other in which one of the linear stripe portion is joined to the first joint surface of the positive electrode lead, and
the second positive electrode current collecting tab group includes a pair of linear stripe portions facing each other in which one of the linear stripe portion is joined to the second joint surface of the positive electrode lead.

12. The secondary battery of claim 10, wherein
the first positive electrode current collecting tab group includes a pair of linear stripe portions facing each other in which the pair of linear stripe portions are joined to the first joint surface, and
the second positive electrode current collecting tab group includes a pair of linear stripe portions facing each other in which the pair of linear stripe portions are joined to the second joint surface of the positive electrode lead.
